(19) United States
(12) Patent Application Publication
(10) Pub. No.: US 2018/0220396 A1
(43) Pub. Date: Aug. 2, 2018

(54) METHOD AND DEVICE FOR COMMUNICATION BASED ON TRUNKING SYSTEM

(71) Applicant: Hytera Communications Corp., Ltd., Shenzhen, Guangdong (CN)

(72) Inventors: Yan Xu, Shenzhen, Guangdong (CN); Chia Han Siong Samuel, Shenzhen, Guangdong (CN); Yingzhe Zhang, Shenzhen, Guangdong (CN); Yang Yu, Shenzhen, Guangdong (CN)

(73) Assignee: Hytera Communications Corp., Ltd., Shenzhen, Guangdong (CN)

(21) Appl. No.: 15/128,720

(22) PCT Filed: Dec. 31, 2014
(86) PCT No.: PCT/CN2014/095924

§ 371 Date: Nov. 21, 2016

(30) Foreign Application Priority Data
Mar. 26, 2014 (CN) 201410117702.8

(51) Int. Cl. H04W 72/04

(52) U.S. Cl. CPC H04W 72/042; H04W 84/047; H04W 72/0446

(57) ABSTRACT

A method and device for communication based on a trunking system. A first repeater sends an identifier of a free repeater and state information of the first repeater to a terminal, the free repeater being a repeater designated from repeaters which are of pre-set type having at least one idle timeslot channel; when the terminal analyses the state information of the first repeater to find that the first repeater has an idle timeslot channel, and a pre-set main repeater is the first repeater, the terminal uses the first repeater to perform communication; and when the terminal analyses the state information of the first repeater to find that all timeslot channels of the first repeater are occupied, if the terminal does not participate in data communication of the first repeater, the terminal accesses the free repeater to perform communication.

### CROSS REFERENCE TO RELATED APPLICATION

The present application claims the priority to Chinese Patent Application No. 201410117702.8, titled “COMMUNICATION METHOD BASED ON TRUNKING SYSTEM, REPEATER and TERMINAL”, filed on Mar. 26, 2014 with the State Intellectual Property Office of the People's Republic of China, which is incorporated herein by reference in its entirety.

### TECHNICAL FIELD

The present disclosure relates to the field of communication, and in particular to a communication method and device based on a trunking system.

### BACKGROUND

A trunking communication system, which is shown in FIG. 1, includes a terminal (an interphone), a service repeater, a control repeater and a control management center. The service repeater and the control repeater include channel resources. In the trunking communication system, the control management center is configured to manage and allocate the channel resources. In a case that the terminal does not make a call or receive a call, the terminal watches at the control repeater. In a case that the terminal is to make a call, the terminal needs to send a request to the control management center via the control repeater, and after the control management center allocates a service repeater for the terminal, the terminal switches to the allocated service repeater to make a call.

Therefore, in the existing trunking communication systems, a service repeater and a control management center are indispensable in the communication process of the terminal, which increases a setup cost of the trunking communication system.

### SUMMARY

A communication method based on a trunking system is provided according to embodiments of the present disclosure, aimed at solving a problem of high setup cost of a trunking communication system caused by the fact that a service repeater and a control management center must participate in a communication process of a terminal.

To achieve the above aim, the following technical solutions are provided by the embodiments of the present disclosure.

A communication method based on a trunking system is provided, which includes:

transmitting, by a first repeater, an identifier of a free repeater and state information of the first repeater to a terminal, where the free repeater is a pre-designated one of pre-set type of repeaters, each of the preset-type of repeaters has at least one idle timeslot channel, and the state information of the first repeater indicates occupation situations of timeslot channels of the first repeater;

performing, by the terminal, communication by means of the first repeater, in a case that it is analysed by the terminal, from the state information of the first repeater, that the first repeater has an idle timeslot channel, and the first repeater is a pre-set main repeater; and

accessing, by the terminal, to the free repeater to perform communication, in a case that it is analysed by the terminal, from the state information of the first repeater, that all timeslot channels of the first repeater are occupied, and the terminal does not participate in current data communication of the first repeater.

A trunking-based communication method is provided, which includes:

receiving, by a terminal, an identifier of a free repeater and state information of a first repeater transmitted by the first repeater, where the free repeater is a pre-designated one of pre-set type of repeaters, each of the preset-type of repeaters has at least one idle timeslot channel, and the state information of the first repeater indicates occupation situations of timeslot channels of the first repeater;

performing, by the terminal, communication by means of the first repeater, in a case that it is analysed by the terminal, from the state information of the first repeater, that the first repeater has an idle timeslot channel, and the first repeater is a pre-set main repeater; and

accessing, by the terminal, to the free repeater to perform communication, in a case that it is analysed by the terminal, from the state information of the first repeater, that all timeslot channels of the first repeater are occupied, and the terminal does not participate in current data communication of the first repeater.

A repeater is provided, which includes:

a first processor configured to transmit an identifier of a free repeater and state information of a first repeater to a terminal, where the free repeater is a pre-designated one of pre-set type of repeaters, each of the preset-type of repeaters has at least one idle timeslot channel, and the state information of the repeater indicates occupation situations of timeslot channels of the first repeater; and

a first memory configured to store programs running in the first processor and data generated during running of the programs.

A terminal is provided, which includes:

a receiver configured to receive an identifier of a free repeater and state information of a first repeater transmitted by the first repeater, where the free repeater is a pre-designated one of pre-set type of repeaters, each of the preset-type of repeaters has at least one idle timeslot channel, and the state information of the first repeater indicates occupation situations of timeslot channels of the first repeater;

a second processor configured to perform communication by means of the first repeater, in a case that it is analysed by the terminal, from the state information of the first repeater, that the first repeater has an idle timeslot channel, and the first repeater is a pre-set main repeater; and accesses to the free repeater to perform communication, in a case that it is analysed by the terminal, from the state information of the first repeater, that all timeslot channels of the first repeater are occupied, and the terminal does not participate in current data communication of the first repeater; and

a second memory configured to store programs in the second processor and data generated during running of the programs.

With the method and the device according to the present disclosure, in a case that a main repeater for a terminal has an idle timeslot channel, the terminal performs communication preferably on its main repeater, and in a case that the main repeater for the terminal is busy, the terminal switches to a free repeater to perform communication. Therefore, with the method according to the present disclosure, the repeater can be configured to schedule timeslot channels for the terminal and serve for both data communication and terminal scheduling, without a control management center or a special control repeater. Thus, a setup cost of a trunking communication system is reduced.

### BRIEF DESCRIPTION OF THE DRAWINGS

To illustrate technical solutions according to embodiments of the present disclosure or in the conventional technologies more clearly, drawings to be used in the descriptions of the embodiments or the conventional technologies are described briefly hereinafter. Apparently, the drawings described hereinafter are only for some embodiments of the present disclosure, and other drawings may be obtained by those skilled in the art based on those drawings without creative efforts.

FIG. 1 is a schematic structural diagram of a trunking communication system;

FIG. 2 is a schematic structural diagram of a digital mobile radio communication system;

FIG. 3 is a flow chart of a communication method based on a trunking communication system according to an embodiment of the present disclosure;

FIG. 4 is a flow chart of a communication method based on a trunking communication system according to another embodiment of the present disclosure;

FIG. 5 is a schematic structural diagram of short LC of CACH in a communication method based on a trunking communication system according to an embodiment of the present disclosure;

FIG. 6 is a schematic structural diagram of Voice LC in a communication method based on a trunking communication system according to an embodiment of the present disclosure;

FIG. 7 is a schematic structural diagram of PreCSBK in a communication method based on a trunking communication system according to an embodiment of the present disclosure;

FIG. 8 is a schematic structural diagram of site state information in a communication method based on a trunking communication system according to an embodiment of the present disclosure;

FIG. 9 is a schematic structural diagram of a repeater according to an embodiment of the present disclosure;

FIG. 10 is a schematic structural diagram of a terminal according to an embodiment of the present disclosure;

FIG. 11 is a schematic structural diagram of a repeater according to another embodiment of the present disclosure; and

FIG. 12 is a schematic structural diagram of a terminal according to another embodiment of the present disclosure.

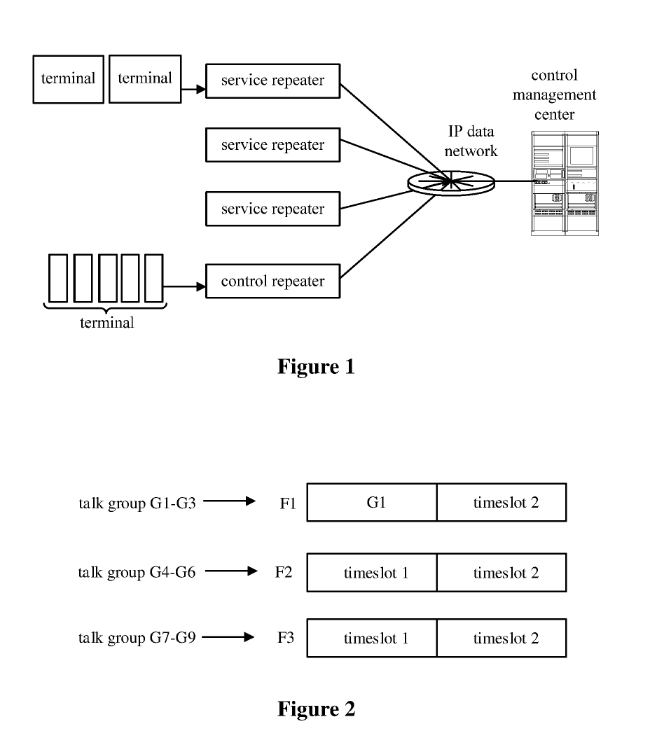

### DETAILED DESCRIPTION OF THE EMBODIMENTS

Embodiments of the present disclosure apply to a trunking communication system. In the embodiments of the present disclosure, digital mobile radio (DMR) is taken as an example. As shown in FIG. 2, the trunking communication system includes a repeater and a terminal. The repeater has repeater frequency points. In the DMR, one repeater corresponds to two logical channel timeslots. That is, for each added repeater frequency point, two logical channel timeslots are added. For example, a repeater 1 includes three repeaters (F1, F2 and F3) and six logical channel timeslots. It should be noted that, in different time division multiple access communication systems, one repeater corresponds to different numbers of logical channel timeslots. For example, in time division multiple access four-timeslot communication, one repeater corresponds to four logical channel timeslots. Therefore, the embodiments of the present disclosure take DMR as an example, but not limited to hereto.

The method according to the embodiment of the present disclosure can support a single site trucked mode or an internet protocol (IP) interconnected multiple-site trucked mode.

Hereinafter technical solutions of the embodiments of the present disclosure are illustrated clearly and completely with drawings of the embodiments of the present disclosure. Apparently, the described embodiments are merely a few rather than all of the embodiments of the present disclosure. All other embodiments obtained by persons of ordinary skill in the art based on the embodiments of the present disclosure without creative efforts shall fall within the protection scope of the present disclosure.

A communication method based on a trunking system is provided according to an embodiment of the present disclosure, which is applied to a trunking communication system shown in FIG. 2. In the trunking communication system, a repeater F1 is set as a main repeater for a terminal G1, a terminal G2 and a terminal G3 in advance, a repeater F2 is set as a main repeater for a terminal G4, a terminal G5 and a terminal G6 in advance, and a repeater F3 is set as a main repeater for a terminal G7, a terminal G8 and a terminal G8 in advance. In the embodiment, main repeaters may be allocated for terminals equally based on the number of the terminals. Alternatively, main repeaters may be allocated for terminals in another way, such as in a random designation mode. In the embodiment, the trunking communication system may be an extended trunking communication system.

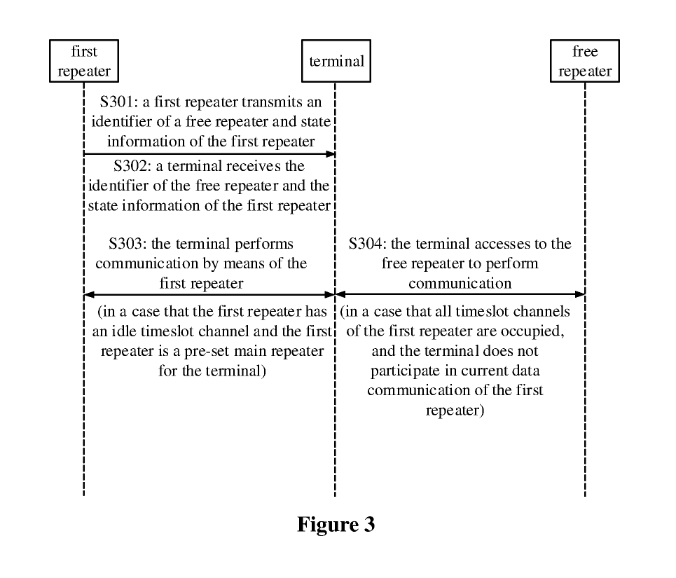

As shown in FIG. 3, the method according to the embodiment of the present disclosure includes steps S301 to S304.

In step S301, a first repeater (any one of F1, F2 and F3) transmits an identifier of a free repeater and state information of the first repeater to terminals (all terminals G1 to G9).

The free repeater is a pre-designated one of pre-set type of repeaters, with each of the preset-type of repeaters having at least one idle timeslot channel. In the embodiment, a free repeater may be one of pre-set type of repeaters which is pre-designated based on a sequence number of each repeater. For example, in a case that each of F1, F2 and F3 has an idle timeslot channel, the repeater F1 is pre-designated as the free repeater.

In step S302, the terminals receive the identifier of the free repeater and the state information of the first repeater transmitted by the first repeater.

In step S303, the terminals perform communication by means of the first repeater, in a case that it is analysed by the terminal, from the state information of the first repeater, that the first repeater has an idle timeslot channel, and the first repeater is a pre-determined main repeater for the terminal.

In the embodiment, that the terminals performing communication by means of the first repeater includes the terminals performing an interception on the first repeater, initiating a call on the first repeater, or receiving a call on the first repeater.

In step S304, the terminals access to the free repeater to perform communication, in a case that it is analysed by the terminal, from the state information of the first repeater, that all timeslot channels of the first repeater are occupied, and the terminal does not participate in current data communication of the first repeater.

As shown in FIG. 2, for example, G1, G2 and G3 perform an interception on F1 after being powered on. It is assumed that a timeslot channel 1 of F1 is occupied and a timeslot channel 2 of F1 is idle, and F2 is pre-designated as the free repeater. F1 transmits an identifier of F2 and state information of F1 to group members of talk groups G1, G2 and G3, and informs terminals within the coverage of F1 of occupation situations of timeslot channels of F1. Each terminal analyses the received state information of F1 and determines that F1 has an idle timeslot channel, and thus the group members of G1, G2 and G3 perform an interception or make a call on F1.

For another example, G1, G2 and G3 perform an interception on F1 after being powered on. It is assumed that all timeslot channels of F1 are occupied, and F2 is pre-designated as the free repeater. F1 transmits the identifier of F2 and the state information of F1 to group members of talk groups G1, G2 and G3, and informs terminals within the coverage of F1 of occupation situations of timeslot channels of F1. Each terminal analyses the received state information of F1 and determines that all timeslot channels on F1 are occupied, and thus terminals which are within the coverage of F1 and do not participate in a call access to F2 to perform an interception.

As can be seen from the above process, a terminal determines, based on the information broadcasted by a main repeater for the terminal, whether to initiate a call on an idle timeslot channel of the main repeater for the terminal or to switch to a free repeater to perform communication. Therefore, with the method according to the embodiment, the repeater can be configured to schedule timeslot channels for a terminal and serve for both data communication and terminal scheduling, without a control management center or a special control repeater. Thus, a setup cost of a trunking communication system is reduced.

In addition, with the method of the embodiment, when a main repeater for a terminal is busy, the terminal can access to a free repeater to perform communication. Therefore, the terminal can share channel resources, and hence, a success rate of accessing a terminal and a utilization ratio of channels are improved. Further, compared with the conventional technology, the terminal does not need to queue on a control channel to wait a release of a channel and does not need to switch from the control channel to a service channel before making a call. Hence, a time delay for setting up a call can be decreased when the terminal initiates a call.

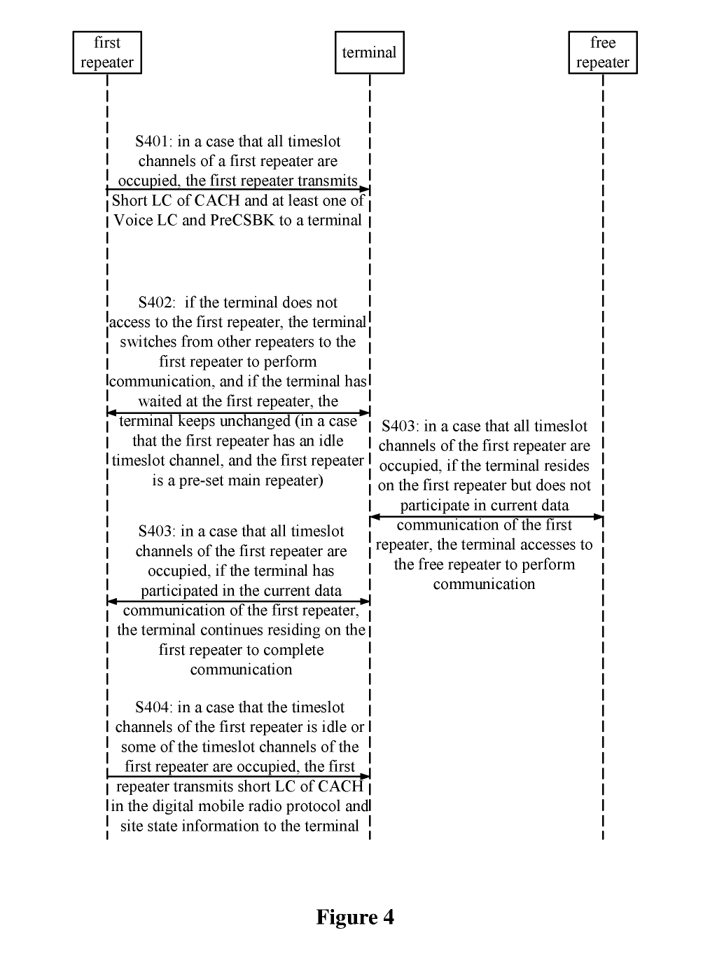

Another communication method based on a trunking system is provided according to an embodiment of the present disclosure, which is applied to a trunking communication system shown in FIG. 2. As shown in FIG. 4, the method according to the embodiment of the present disclosure includes steps S401 to S404.

In step S401, if all timeslot channels of a first repeater (any one of F1, F2 and F3) are occupied, the first repeater transmits, on the occupied timeslot channels, Short Link Control (Short LC) signaling of a Common Announcement Channel (CACH) and one of voice link control signaling Voice LC and pre-carrier signaling (pre control signaling block, PreCSBK) to terminals (all terminals G1 to G9).

In the embodiment, the first repeater may monitor occupation situations of timeslot channels of itself in a real-time manner, and the first repeater triggers S401 to be executed once the timeslot channels of itself are occupied.

If all timeslot channels of the repeater are occupied, it indicates that the repeater is in a non-idle operating state, the repeater may forward voice data, a short message or control signaling to the terminals. Therefore, in addition to the short LC of CACH, the repeater may also transmit one of the voice link control signaling Voice LC and the pre-carrier signaling PreCSBK to the terminals.

In the embodiment, short LC of CACH carries an identifier of the free repeater, and CACH carries the state information indicating an occupation situation of each timeslot channel of the first repeater. Generally, occupation situations of the timeslot channels may be indicated by setting a value of an access type in CACH. Voice LC and PreCSBK carry the identifier of the free repeater.

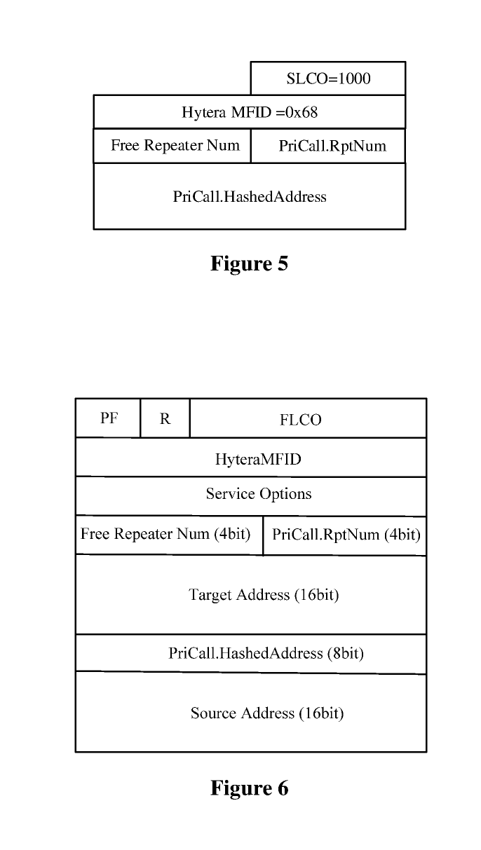

In the embodiment, the short LC of CACH is shown in FIG. 5, and remarks of various parts thereof are shown in Table 1:

TABLE 1

| Information Element | Length | Value | Remark |
|---|---|---|---|
| short link operation code SLCO | 4 | 0x08 | applied to extended trunking |
| manufacturer's identification | 8 | 0x68 | an characteristic identification code with a |
| MFID | | | function self-defined by Hytera company |
| free repeater number | 4 | 0~15 | 0 indicates that all channels of a repeater within |
| Free Repeater Num | | | a site are busy, and 1 to 15 indicate an index |
| | | | number of a current free repeater |
| repeater number of priority call | 4 | 1~15 | indicating an index number of a repeater |
| PriCall.RptNum | | | forwarding a priority call |
| hashed address of priority call | 8 | 0~255 | indicating 8-bit hashed address of a priority call |
| PriCall.HashedAddress | | | |

Voice LC is shown in FIG. 6, and remarks of various parts thereof are shown in Table 2:

TABLE 2

| Information Element | Length | Value | Remark |
|---|---|---|---|
| protective flag PF | 1 | 0 | undefined, the default being 0, and reserved for |
| | | | future use |
| reserved bit R | 1 | 0 | reserved bit and the default being 0 |
| full link control operation code | 6 | | having different values for an individual call, a |
| FLCO | | | group call and a data end frame |
| manufacturer's identification | 8 | 0x68 | an characteristic identification code with a function |
| MFID | | | self-defined by Hytera company |
| free repeater number | 4 | 0~15 | 0 indicates that all channels of a repeater within a |
| Free Repeater Num | | | site are busy, and 1 to 15 indicate an index number |
| | | | of a current free repeater |
| repeater number of priority call | 4 | 1~15 | indicating an index number of a repeater |
| PriCall.RptNum | | | forwarding a priority call |
| target address | 16 | 1~65535 | a target address of a call |
| Target Address | | | |
| hashed address of priority call | 8 | 0~255 | indicating 8-bit hashed address of a priority call |
| PriCall.HashedAddress | | | |
| Source address | 16 | 1~65535 | a source address of a call |
| Source Address | | | |

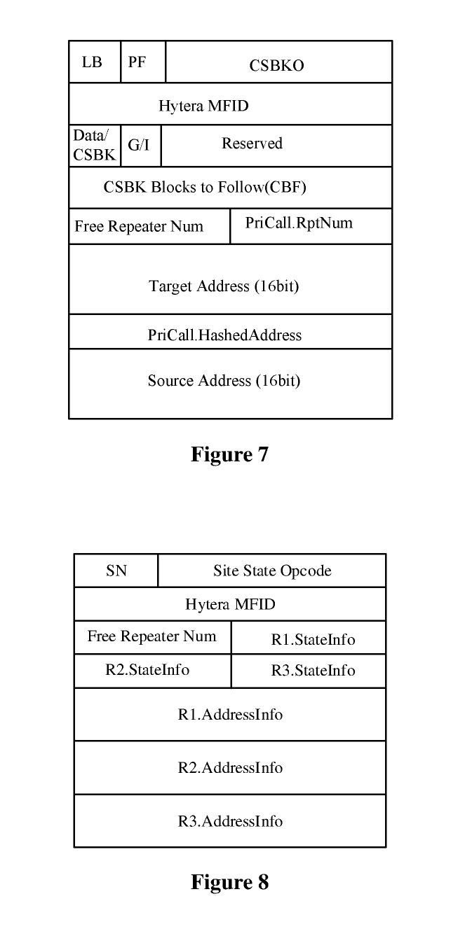

PreCSBK is shown in FIG. 7, and remarks of various parts thereof are shown in Table 3:

TABLE 3

| Information Element | Length | Value | Remark |
|---|---|---|---|
| flag of last block LB | 1 | 1 | the last block of CSBK or MBC is set to be 1 |
| protective flag PF | 1 | 0 | undefined, the default being 0, and reserved for |
| | | | future use |
| control signaling block | 6 | 0x3d | control signaling block operation code of a |
| operation code CSBKO | | | pre-carrier |
| manufacturer's identification | 8 | 0x68 | an characteristic identification code with a function |
| MFID | | | self-defined by Hytera company |
| data or control signaling | 1 | 0/1 | 0 indicates that a pre-carrier is followed by a |
| Data/CSBK | | | control signaling frame, and 1 indicates that the |
| | | | pre-carrier is followed by data |
| group call/individual call | 1 | 0/1 | 0 indicates an individual call, and 1 indicates a |
| G/I | | | group call |
| reserved bit R | 6 | 0 | reserved bit and the default being 0 |
| control signaling block | 8 | | the number of control signaling blocks following |
| following | | | the current pre-carrier |
| CBF | | | |
| free repeater number | 4 | 0~15 | 0 indicates that all channels of a repeater within a |
| Free Repeater Num | | | site are busy, and 1 to 15 indicate an index number |
| | | | of a current free repeater |
| repeater number of priority call | 4 | 1~15 | indicating an index number of a repeater |
| PriCall.RptNum | | | forwarding a priority call |
| target address | 16 | 1~65535 | a target address of a call |
| Target Address | | | |
| hashed address of priority call | 8 | 0~255 | indicating 8-bit hashed address of a priority call |
| PriCall.HashedAddress | | | |
| source address | 16 | 1~65535 | a source address of a call |
| Source Address | | | |

In step S402, if it is analyzed by the terminal, from short LC of CACH transmitted by the first repeater, that the first repeater has an idle timeslot channel, and the first repeater is a pre-set main repeater, if there is no call to the terminal on other repeaters, the terminal connects to the first repeater to perform communication.

In step S403, if it is analysed by the terminal, from the state information of the first repeater, that all timeslot channels of the first repeater are occupied, in a case that the terminal resides on the first repeater, but does not participate in current data communication of the first repeater, the terminal accesses to the free repeater to perform communication; and in a case that the terminal has participated in current data communication of the first repeater, the terminal continues residing on the first repeater to complete communication processes.

In the embodiment, the short LC of CACH carries an identifier of the free repeater for informing the terminal of the occupation situation, and the terminal may also learn, from short LC of CACH, the occupation situation of timeslot channels of the first channel. Therefore, in a case that the first repeater is a pre-set main repeater for the terminal, and the first repeater has an idle timeslot channel, the terminal may perform communication preferably on the first repeater. In a case that all timeslot channels of the first repeater are occupied, the terminal may switch to the free repeater to perform communication and does not need to queue and wait on the first repeater.

Voice LC and PreCSBK also carry the identifier of the free repeater, so that the terminal learns the identifier of the free repeater while the repeater forwards a call, a short message and control signaling.

In step S404, in a case that the timeslot channels of the first repeater are idle or some of the timeslot channels of the first repeater are occupied, the first repeater transmits the short LC of CACH and site state information to the terminal.

The site state information includes occupation situations of various timeslot channels of each repeater and the identifier of the free repeater.

In the embodiment, the first repeater may transmit short LC of CACH and the site state information to the terminal in a pre-set frequency. Since the first repeater is idle, periodical broadcasting can avoid transmitting on a frequency point for a long time.

In the embodiment, the site state information is shown in FIG. 8, and remarks of various parts thereof are shown in Table 4:

TABLE 4

| Information Element | Length | Value | Remark |
|---|---|---|---|
| sequence number | 2 | | 0 indicates a first frame of site state information, including |
| SN | | | timeslot channel information of repeater 1 to repeater 3 within a |
| | | | site; |
| | | | 1 indicates a second frame of site state information, including |
| | | | timeslot channel information of repeater 4 to repeater 6 within a |
| | | | site; |
| | | | 2 indicates a third frame of site state information, including |
| | | | timeslot channel information of repeater 7 to repeater 9 within a |
| | | | site; |
| | | | 3 is reserved for future use |
| site state operation | 6 | 0x0A | site state information operation code |
| code | | | |
| Site State Opcode | | | |
| manufacturer's | 8 | 0x68 | an characteristic identification code with a function self-defined |
| identification | | | by Hytera company |
| MFID | | | |
| free repeater number | 4 | 0~15 | 0 indicates that all channels of a repeater within a site are busy, |
| Free Repeater Num | | | and 1 to 15 indicate an index number of a current free repeater |

In the embodiment, the first repeater may be any of repeaters in a trunking system. If all timeslot channels of pre-set type of repeaters except the first repeater are idle, the pre-set type of repeaters periodically transmit the short link control signaling short LC of the common announcement channel CACH in a digital mobile radio protocol and the site state information. When receiving the site state information, the terminal may analyse a current state of the main repeater for the terminal and the identifier of the free repeater. In a case that the terminal does not transceiver data, if the main repeater for the terminal has an idle timeslot channel, the terminal returns back to the main repeater for the terminal, and if the main repeater for the terminal has no idle timeslot channel, the terminal accesses to the free repeater to perform communication.

By receiving the site state information broadcasted by a system, a terminal user may know a communication situation of each repeater (including the main repeater) within a site and learn states of the current free repeater and the main repeater. Therefore, the terminal can quickly switch to a repeater frequency point which transfers a call of the terminal and access to the call, and the main repeater busily and quickly switches to the free repeater to monitor, and after the call ends, the terminal quickly returns to the main repeater for itself, which improves the performance of the call access of the extended trunking system.

It should be noted that, in the above embodiment, the free repeater may be determined complying with the following rules.

The free repeater is selected from a list of idle repeaters, and there is only one free repeater within the site at the same time. If all timeslot channels of the free repeater are occupied, the free repeater re-selects, according to per-set rules, a free repeater from the per-set type repeaters.

The free repeater may designate a new free repeater from idle repeaters according to a sequence of each repeater. For example, in FIG. 2, if two timeslots of the previous free repeater F2 are occupied, F2 becomes a busy repeater. F2 designates a new free repeater F3, and according to the method described in the above embodiments, talk group members of G5 and G6 residing on F2 which do not participate in the call switch to the new free repeater F3 according to the received information.

That is, the new free repeater is always designated by the previous free repeater. If the free repeater is abnormal, and other repeaters within the site detect that the free repeater is offline, each repeater determines by itself whether it needs to become a free repeater. For example, if R3 is abnormal, R4 will become a new free repeater.

After the free repeater is changed, all repeaters within the site change the free repeater. In the above embodiment, when receiving the updated free repeater information, the first repeater or the pre-set type of repeaters update the information of free repeater embedded in the short link control signaling Short LC of the common announcement channel CACH and one of voice link control signaling Voice LC and pre-carrier signaling PreCSBK in a digital mobile radio protocol transmitted to the terminal.

In the above embodiment, following situations may be included.

First, when the terminal initiates a new call while receiving a call or hanging a call, the terminal detects whether the main repeater for the terminal has an idle channel timeslot.

In a case that the terminal detects that the main repeater for the terminal has an idle timeslot channel, the terminal stops receiving the call and switches to the main repeater for the terminal to initiate a new call. In a case that the terminal detects that the main repeater for the terminal has no idle timeslot channel, the terminal stops receiving the call and switches to the free repeater to initiate a new call.

For example, as shown in FIG. 2, a writing-frequency configuration of a group member A may receive a call of a talk group G1 and G2. When receiving a call from a group call G1 on a timeslot 1 of F1, if the group member A has something urgent to do and needs to initiate a call to call G2, the group member A stops receiving the call of G1 and initiates the call to call G2 on an idle channel timeslot 2 of the main repeater F1 of the group member A.

A writing-frequency configuration of a group member B may receive a call of a talk group G2 and G3. When receiving a call from a group call G2 on a timeslot 2 of F1, if the group member B has something urgent to do and needs to initiate a call to call G3, but the main repeater of the group member B has no idle timeslot, the member group B stops receiving the call of G2, switches to a free repeater F2 and initiates the call to call G3 on an idle channel timeslot 1 of the free repeater F2.

If a repeater on which the terminal receives the call or maintains the call is neither the main repeater for the terminal nor the current free repeater, the terminal switches to the main repeater for the terminal before detecting whether the main repeater for the terminal has an idle channel timeslot, and detects whether the main repeater for the terminal has an idle channel timeslot. In a case that the terminal detects that the main repeater for the terminal has an idle timeslot, the terminal stops receiving the call and switches to the main repeater for the terminal to initiate a new call, and in a case that the terminal detects that the main repeater for the terminal has no idle timeslot, the terminal stops receiving the call and switches to the free repeater to initiate a new call.

Second, when a voice link end frame transmitted by terminal is received by the first repeater, the pre-set type of repeaters or the free repeater, the repeater broadcasts the voice link end frame within a pre-set time period if the repeater is idle, and the repeater transmits site state information when the pre-set time period is expired.

If the terminal initiates a callback while hanging a call, a timeslot channel on which the call is maintained is used to initiate the callback. If the site state information is received by the terminal, it indicates a real end of this call.

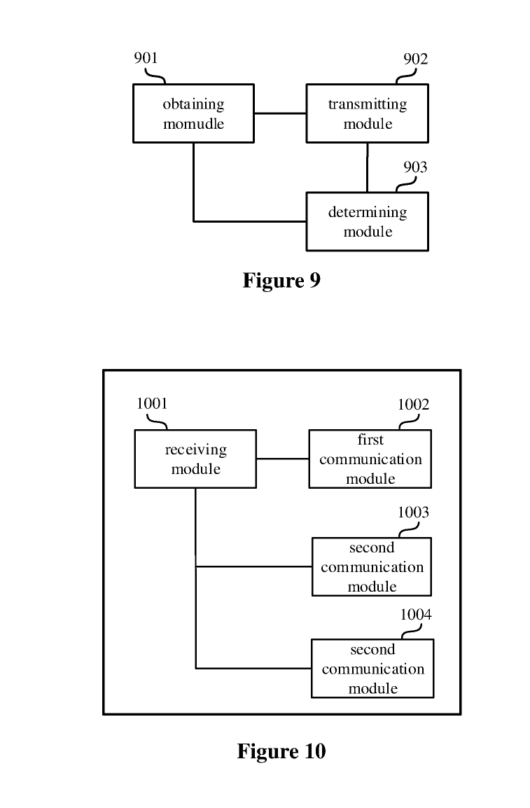

Corresponding to the above embodiments, a repeater is disclosed according to an embodiment of the disclosure. As shown in FIG. 9, the repeater includes an obtaining module 901 configured to obtain an identifier of a free repeater and a transmitting module 902.

The transmitting module 902 is configured to transmit the identifier of the free repeater and state information of the repeater. The free repeater is a pre-designated one of repeaters each having at least one idle timeslot channel, and the state information of the repeater indicates occupation situations of timeslot channels of the repeater. The terminal performs communicate by means of the repeater, in a case that it is analysed by the terminal, from the state information of the repeater, that the repeater has an idle timeslot channel, and the repeater is a pre-set main repeater. The terminal accesses to the free repeater to perform communication, in a case that it is analysed by the terminal, from the state information of the repeater, that all timeslot channels of the repeater are occupied, and the terminal does not participate in current data communication of the repeater.

The transmitting, by the transmitting module, the identifier of the free repeater and the state information of the repeater to the terminal may include:

transmitting, by the transmitting module if all timeslot channels of the repeater are occupied, short link control signaling Short LC of the common announcement channel CACH and one of voice link control signaling Voice LC and pre-carrier signaling PreCSBK in a digital mobile radio protocol to the terminal.

The common announcement channel CACH in the digital mobile radio protocol carries the state information indicating an occupation situation of each timeslot channel of the repeater. The short link control signaling Short LC of the common announcement channel CACH in the digital mobile radio protocol carries the identifier of the free repeater. The voice link control signaling Voice LC or the pre-carrier signaling PreCSBK carries the identifier of the free repeater.

The transmitting module in the embodiment may be further configured to:

transmit, if the timeslot channels of the repeater are idle or some of the timeslot channels of the repeater are occupied, the short link control signaling Short LC of the common announcement channel CACH in the digital mobile radio protocol and site state information to the terminal. The site state information includes an occupation situation of each timeslot channel of each repeater within a site and the identifier of the free repeater.

The transmitting, by the transmitting module if the timeslot channels of the repeater are idle or some of the timeslot channels of the repeater are occupied, the short link control signaling Short LC of the common announcement channel CACH in the digital mobile radio protocol and the site state information to the terminal may include:

periodically transmitting, by the transmitting module, the short link control signaling Short LC of the common announcement channel CACH in the digital mobile radio protocol and the site state information, if all timeslot channels of the repeater are idle.

The repeater may further include a determining module 903, which is configured to re-determine, if all timeslot channels of the repeater are occupied, a free repeater from the pre-set type of repeaters according to a pre-set rule, and to inform other repeaters within the site to update information of the free repeater.

The transmitting module may be further configured to update, when receiving the updated information of the free repeater, the information of the free repeater embedded in the short link control signaling Short LC of the common announcement channel CACH and one of the voice link control signaling Voice LC and the pre-carrier signaling PreCSBK in the digital mobile radio protocol transmitted by the transmitting module to the terminal.

The transmitting module is further configured to: broadcast, by the repeater when receiving the voice link end frame transmitted by the terminal, a voice link end frame within a pre-set time period if the repeater is idle, and transmit the site state information by the repeater when the pre-set time period is expired.

The repeater according to the embodiment transmits the occupation situation of the timeslot channels and the identifier of the pre-set free repeater to the terminal in advance. Therefore, the repeater when being applied to a trunking communication system has a function of scheduling a terminal without setting up a control management center and a special control repeater in the trunking system, thereby saving a setup cost of a trunking communication system.

A terminal is further disclosed according to an embodiment of the present disclosure shown in FIG. 10, which includes:

a receiving module 1001 configured to receive an identifier of a free repeater and state information of a first repeater transmitted by the first repeater, where the free repeater is a pre-designated one of pre-set type of repeaters, each of the preset-type of repeaters has at least one idle timeslot channel, and the state information of the first repeater indicates occupation situations of timeslot channels of the first repeater; and

a first communication module 1002 configured to perform communication by means of the first repeater, in a case that it is analyzed by the terminal, from the state information of the first repeater, that the first repeater has an idle timeslot channel, and the first repeater is a pre-set main repeater; and accesses to the free repeater to perform communication, in a case that it is analyzed by the terminal, from the state information of the first repeater, that all timeslot channels of the first repeater are occupied, and the terminal does not participate in current data communication of the first repeater.

The first communication module 1002 being configured to perform communication by means of the first repeater, in a case that it is analyzed by the terminal, from the state information of the first repeater, that the first repeater has an idle timeslot channel, and the first repeater is the pre-set main repeater includes:

the first communication module 1002 being configured to connect to the first repeater to perform communication, in a case that it is analysed by the terminal, from the state information of the first repeater, that the first repeater has an idle timeslot channel, and the first repeater is the pre-set main repeater for the terminal, and if there is no call to the terminal on other repeaters.

Optionally, the terminal further includes:

a second communication module 1003 configured to, when receiving state information of all repeaters, analyse a current state of the main repeater and the identifier of the free repeater of the terminal, return back to the main repeater for the terminal in a case that the terminal does not perform data communication and the main repeater for the terminal has an idle timeslot channel, and access to the free repeater to perform communication in a case that the terminal does not perform data communication and the main repeater for the terminal has no idle timeslot channel; and

a third communication module 1004 configured to detect whether the main repeater for the terminal has an idle timeslot channel, when the terminal initiates a new call while receiving a call or hanging a call; stop receiving the call and switch to the main repeater for the terminal to initiate a new call, in a case that the main repeater for the terminal has an idle timeslot channel; and stop receiving the call and switch to the free repeater to initiate a new call, in a case that the main repeater for the terminal has no idle timeslot channel.

The third communication module 1004 is further configured to:

switch to the main repeater for the terminal before detecting whether the main repeater for the terminal has an idle channel timeslot, if a repeater on which the terminal receives the call or maintains the call is neither the main repeater for the terminal nor the current free repeater; and use the timeslot channel, on which the call is maintained, to call back, if the terminal initiates a callback while hanging a call.

The terminal according to the embodiment can perform communication preferably on a main repeater by receiving information from a repeater, and automatically switch to a free repeater when the main repeater is busy. Therefore, a time delay of communication in a trunking communication system can be decreased.

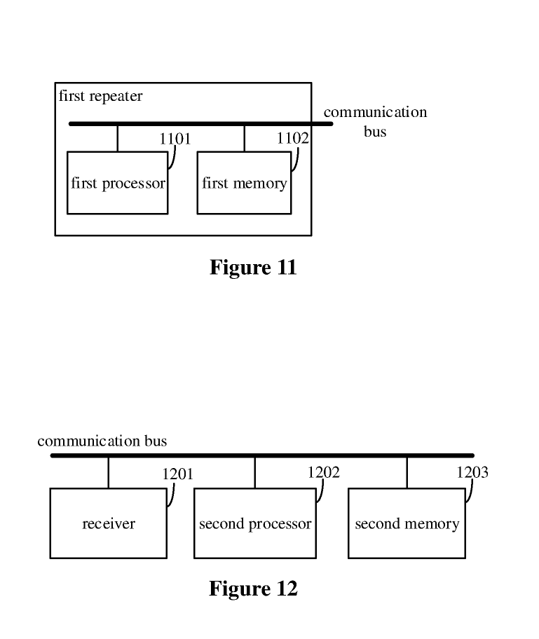

Another repeater is further disclosed according to an embodiment of the disclosure shown as FIG. 11, which includes a first processor 1101 and a first memory 1102.

The first processor 1101 is configured to transmit an identifier of a free repeater and state information of the repeater to a terminal. The free repeater is a pre-designated one of pre-set type of repeaters, each of the preset-type of repeaters has at least one idle timeslot channel; the state information of the repeater indicates occupation situations of timeslot channels of the repeater. The terminal performs communication by means of the repeater, in a case that it is analyzed by the terminal, from the state information of the repeater, that the repeater has an idle timeslot channel, and the repeater is a pre-set main repeater. The terminal accesses to the free repeater to perform communication, in a case that it is analysed by the terminal, from the state information of the repeater, that all timeslot channels of the repeater are occupied, and the terminal does not participate in current data communication of the repeater

The first memory 1102 is configured to store programs running in the first processor and data generating in the process of running of the programs.

Further, the transmitting, by the first processor, the identifier of the free repeater and the state information of the repeater to the terminal may include: transmitting, by the first processor, short link control signaling Short LC of the common announcement channel CACH in a digital mobile radio protocol to the terminal and one of voice link control signaling Voice LC and pre-carrier signaling PreCSBK, if all timeslot channels of the repeater are occupied.

The common announcement channel CACH in the digital mobile radio protocol carries the state information indicating an occupation situation of each timeslot channel of the repeater. The short link control signaling Short LC of the common announcement channel CACH in the digital mobile radio protocol carries the identifier of the free repeater. The voice link control signaling Voice LC or the pre-carrier signaling PreCSBK carries the identifier of the free repeater.

The first processor is further configured to transmit, in a case that timeslot channels of the repeater are idle or some of the timeslot channels of the repeater are occupied, the short link control signaling Short LC of the common announcement channel CACH in the digital mobile radio protocol and site state information to the terminal. The site state information includes an occupation situation of each timeslot channel of each repeater within a site and the identifier of the free repeater. Further, the transmitting, by the first processor in a case that the timeslot channels of the repeater are idle or some of the timeslot channels of the repeater are occupied, the short link control signaling Short LC of the common announcement channel CACH in the digital mobile radio protocol and the site state information to the terminal may include:

periodically transmitting, by the first processor, the short link control signaling Short LC of the common announcement channel CACH in the digital mobile radio protocol and the site state information, in a case that all timeslot channels of the repeater are idle.

The first processor 1101 may be further configured to re-determine a free repeater from pre-set type of repeaters according to a pre-set rule and inform other repeaters within the site to update information of the free repeater, in a case that all timeslot channels of the free repeater are occupied.

Further, in the embodiment, the first processor may be further configured to update, when receiving the updated free repeater information, the information of the free repeater embedded in the short link control signaling Short LC of the common announcement channel CACH and one of voice link control signaling Voice LC and pre-carrier signaling PreCSBK in a digital mobile radio protocol transmitted by the first processor to the terminal.

The first processor may be further configured to broadcast, by the repeater when receiving the voice link end frame transmitted by terminal, a voice link end frame within a pre-set time period if the repeater is idle. When the pre-set time period is expired, the repeater transmits site state information.

The repeater of the trunking communication system according to the embodiment has a function of terminal scheduling, and the trunking system does not need to set up a control management center and a special control repeater, thereby saving a setup cost of a trunking communication system. In addition, cooperation among a first repeater, pre-set type of repeaters and a free repeater makes the scheduling for the terminal more flexible.

A terminal is further provided according to an embodiment of the disclosure shown in FIG. 12, which includes a receiver 1201, a second processor 1202 and a second memory 1203.

The receiver 1201 is configured to receive an identifier of a free repeater and state information of a first repeater transmitted by the first repeater, where the free repeater is a pre-designated one of pre-set type of repeaters, each of the preset-type of repeaters has at least one idle timeslot channel, and the state information of the first repeater indicates occupation situations of timeslot channels of the first repeater.

The second processor 1202 is configured to perform communication by means of the first repeater, in a case that it is analysed by the terminal, from the state information of the first repeater, that the first repeater has an idle timeslot channel, and the first repeater is a pre-set main repeater; and accesses to the free repeater to perform communication, in a case that it is analysed by the terminal, from the state information of the first repeater, that all timeslot channels of the first repeater are occupied, and the terminal does not participate in current data communication of the first repeater.

The second memory 1203 is configured to store programs running in the first processor and data generating in the process of running of the programs.

Specifically, the second processor 1202 being configured to perform communication by means of the first repeater, in a case that it is analyzed by the terminal, from the state information of the first repeater, that the first repeater has an idle timeslot channel, and the first repeater is the pre-set main repeater for the terminal may include the four processor being configured to connect to the first repeater to perform communication, in a case that it is analyzed by the terminal, from the state information of the first repeater, that the first repeater has an idle timeslot channel, and the first repeater is the pre-set main repeater, and if there is no call to the terminal on other repeaters.

The second processor 1202 may be further configured to analyse a current state of the main repeater for the terminal and the identifier of the free repeater when receiving state information of all repeaters, return back to the main repeater for the terminal in a case that the terminal does not perform data communication and the main repeater for the terminal has an idle timeslot channel, and access to the free repeater to perform communication in a case that the terminal does not perform data communication and the main repeater for the terminal has no idle timeslot channel. The second processor 1202 may be further configured to detect whether the main repeater for the terminal has an idle timeslot channel, when the terminal initiates a new call while receiving a call or hanging a call; stop receiving the call and switch to the main repeater for the terminal to initiate a new call, in a case that the main repeater for the terminal has an idle timeslot channel; and stop receiving the call and switch to the free repeater to initiate a new call, in a case that the main repeater for the terminal has no idle timeslot channel. The second processor 1202 may be further configured to switch to the main repeater for the terminal, before detecting whether the main repeater for the terminal has an idle timeslot channel, in a case that a repeater on which the terminal receives the call or maintain the call is neither the main repeater for the terminal not the current free repeater. The second processor 1202 may be further configured to use a timeslot channel, on which the call is maintained, to call back, if the terminal initiates a callback while hanging a call.

By receiving information from a repeater, the terminal according to the embodiment can perform communication preferably on a main repeater, and automatically switch to a free repeater when the main repeater is busy. Therefore, a time delay of communication in a trunking communication system can be decreased.

A trunking communication system is further disclosed according to an embodiment of the disclosure, which includes a repeater shown in FIG. 9 and a terminal shown in FIG. 10, or includes a repeater shown in FIG. 11 and a terminal shown in FIG. 12.

The functions according to the embodiment, when being implemented in a form of a soft function unit and sold or used as an independent product, can be stored in a readable storage medium of a computing device. In this respect, a part of the embodiments of the disclosure contributing to the conventional technology or a part of the technical solutions can be embodied in a form of a software product, and the software product is stored in a storage medium. The software product includes several instructions for instructing a computing device (which may be a personal computer, a server, a mobile computing device or a network device) to execute all or some of steps described in various embodiments of the disclosure. The storage medium in the forgoing includes various media capable of storing program codes, such as, a USB disk, a removable hard disk, a read-only memory (ROM), a random access memory (RAM), a magnetic disk, or an optical disk.

The embodiments of the present specification are described in a progressive manner and each embodiment places emphasis on the difference from other embodiments. Therefore, one embodiment can refer to other embodiments for the same or similar parts.

According to the description of the disclosed embodiments, the disclosure can be implemented or used by a person of skills in the art. Various modifications made to these embodiments may be obvious for persons of skills in the art, and a normal principle defined in the disclosure may be implemented in other embodiments without departing from the spirit or scope of the disclosure. Therefore the disclosure is not limited to the embodiments described herein but confirms to a widest scope in accordance with principles and novel features disclosed in the disclosure.

1. A communication method based on a trunking system, comprising:
transmitting, by a first repeater, an identifier of a free repeater and state information of the first repeater to a terminal, wherein
the free repeater is a pre-designated one of pre-set type of repeaters, each of the preset-type of repeaters has at least one idle timeslot channel, and
the state information of the first repeater indicates occupation situations of timeslot channels of the first repeater, and it is analysed by the terminal, from the state information of the first repeater, that the first repeater has an idle timeslot channel.

2. The method according to claim 1, wherein the transmitting, by the first repeater, the identifier of the free repeater and the state information of the first repeater to the terminal comprises:
transmitting, by the first repeater, short link control signaling Short LC of a common announcement channel CACH and one of voice link control signaling Voice LC and pre-carrier signaling PreCSBK in a digital mobile radio protocol to the terminal, in a case that all timeslot channels of the first repeater are occupied,
wherein the common announcement channel CACH in the digital mobile radio protocol carries the state information indicating an occupation situation of each timeslot channel of the first repeater, the short link control signaling Short LC of the common announcement channel CACH in the digital mobile radio protocol carries the identifier of the free repeater, and the voice link control signaling Voice LC or the pre-carrier signaling PreCSBK carries the identifier of the free repeater.

3. The method according to claim 1, further comprising:
transmitting, by the first repeater, short link control signaling Short LC of a common announcement channel CACH in a digital mobile radio protocol and site state information to the terminal, in a case that the timeslot channels of the first repeater are idle or some of the timeslot channels of the first repeater are occupied,
wherein the site state information comprises an occupation situation of each timeslot channel of each repeater within a site and the identifier of the free repeater.

4. The method according to claim 3, wherein in a case that the first repeater is designated as the free repeater, the method further comprises:
re-determining, by the first repeater, a new free repeater from the pre-set type of repeaters according to a pre-set rule, in a case that all timeslot channels of the first repeater are occupied; and
informing, by the first repeater, other repeaters within the site to update information of the free repeater.

5. The method according to claim 4, further comprising:
updating, by the first repeater when receiving the updated information of the free repeater, the information of the free repeater embedded in the short link control signaling Short LC of the common announcement channel CACH and one of the voice link control signaling Voice LC and the pre-carrier signaling PreCSBK in the digital mobile radio protocol transmitted by the first repeater to the terminal.

6. The method according to claim 1, further comprising:
broadcasting, by the first repeater when receiving a voice link end frame transmitted by the terminal, the voice link end frame within a pre-set time period in a case that the first repeater is idle; and transmitting the site state information by the first repeater when the pre-set time period is expired.

7. A communication method based on a trunking system, comprising:
receiving, by a terminal, an identifier of a free repeater and state information of a first repeater transmitted by the first repeater, wherein the free repeater is a pre-designated one of pre-set type of repeaters, each of the preset-type of repeaters has at least one idle timeslot channel, and the state information of the first repeater indicates occupation situations of timeslot channels of the first repeater;
performing, by the terminal, communication by means of the first repeater, in a case that it is analysed by the terminal, from the state information of the first repeater, that the first repeater has an idle timeslot channel, and the first repeater is a pre-set main repeater; and
accessing, by the terminal, to the free repeater to perform communication, in a case that it is analysed by the terminal, from the state information of the first repeater, that all timeslot channels of the first repeater are occupied, and the terminal does not participate in current data communication of the first repeater.

8. The method according to claim 7, wherein the performing, by the terminal, communication by means of the first repeater, in a case that it is analysed by the terminal, from the state information of the first repeater, that the first repeater has an idle timeslot channel, and the first repeater is the pre-set main repeater comprises:
connecting, by the terminal, to the first repeater to perform communication, in a case that it is analysed by the terminal, from the state information of the first repeater, that the first repeater has an idle timeslot channel, the first repeater is the pre-set main repeater, and if there is no call to the terminal on other repeaters.

9. The method according to claim 7, further comprising:
analysing, by the terminal when receiving state information of all repeaters, a current state of the main repeater for the terminal and the identifier of the free repeater; returning, by the terminal, back to the main repeater for the terminal, in a case that the terminal does not perform data communication and the main repeater for the terminal has an idle timeslot channel; and accessing, by the terminal, to the free repeater to perform communication, in a case that the terminal does not perform data communication and the main repeater for the terminal has no idle timeslot channel.

10. The method according to claim 9, further comprising:
detecting, by the terminal, whether the main repeater for the terminal has an idle timeslot channel, when the terminal initiates a new call while receiving a call or hanging a call;
stopping, by the terminal, receiving the call, and switching, by the terminal, to the main repeater for the terminal to initiate a new call, in a case that it is detected by the terminal that the main repeater for the terminal has an idle timeslot channel; and
stopping, by the terminal, receiving the call, and switching, by the terminal, to the free repeater to initiate a new call, in a case that it is detected by the terminal that the main repeater for the terminal has no idle timeslot channel.

11. The method according to claim 10, wherein in a case that a repeater on which the terminal receives the call or maintains the call is neither the main repeater for the terminal nor the current free repeater, the method further comprises: before the terminal detects whether the main repeater for the terminal has an idle channel timeslot,
switching, by the terminal, to the main repeater for the terminal.

12. A repeater, comprising:
a first processor configured to transmit an identifier of a free repeater and state information of a repeater to a terminal, wherein the free repeater is a pre-designated one of pre-set type of repeaters, each of the preset-type of repeaters has at least one idle timeslot channel, and the state information of the repeater indicates occupation situations of timeslot channels of the repeater; and
a first memory configured to store programs running in the first processor and data generated during running of the programs.

13. The repeater according to claim 12, wherein the transmitting, by the first processor, the identifier of the free repeater and the state information of the repeater to the terminal comprises:
transmitting, by the first processor, short link control signaling Short LC of a common announcement channel CACH and one of voice link control signaling Voice LC and pre-carrier signaling PreCSBK in a digital mobile radio protocol to the terminal, in a case that all timeslot channels of the repeater are occupied,
wherein the common announcement channel CACH in the digital mobile radio protocol carries the state information indicating an occupation situation of each timeslot channel of the repeater, the short link control signaling Short LC of the common announcement channel CACH in the digital mobile radio protocol carries the identifier of the free repeater, and the voice link control signaling Voice LC or the pre-carrier signaling PreCSBK carries the identifier of the free repeater.

14. The repeater according to claim 12, wherein the first processor is further configured to:
transmit, in a case that the timeslot channels of the repeater are idle or some of the timeslot channels of the repeater are occupied, short link control signaling Short LC of a common announcement channel CACH in a digital mobile radio protocol and site state information to the terminal,
wherein the site state information comprises an occupation situation of each timeslot channel of each repeater within a site and the identifier of the free repeater.

15. The repeater according to claim 14, wherein the first processor is further configured to:
in a case that the first repeater is designated as the free repeater, re-determine a free repeater from the pre-set type of repeaters according to a pre-set rule, in a case that all timeslot channels of the repeater are occupied; and inform other repeaters within the site to update information of the free repeater.

16. The repeater according to claim 15, wherein the first processor is further configured to:
update, when receiving the updated information of the free repeater, the information of the free repeater embedded in the short link control signaling Short LC of the common announcement channel CACH and one of the voice link control signaling Voice LC and the pre-carrier signaling PreCSBK in the digital mobile radio protocol transmitted by the first processor to the terminal.

17. The repeater according to claim 16, wherein the first processor is further configured to:
broadcast, by the repeater when receiving a voice link end frame transmitted by the terminal, the voice link end frame within a pre-set time period in a case that the repeater is idle; and transmit the site state information by the repeater when the pre-set time period is expired.

18. A terminal, comprising:
a receiver configured to receive an identifier of a free repeater and state information of a first repeater transmitted by the first repeater, wherein the free repeater is a pre-designated one of pre-set type of repeaters, each of the preset-type of repeaters has at least one idle timeslot channel, and the state information of the first repeater indicates occupation situations of timeslot channels of the first repeater;
a second processor configured to perform communication by means of the first repeater, in a case that it is analysed by the terminal, from the state information of the first repeater, that the first repeater has an idle timeslot channel, and the first repeater is a pre-set main repeater; and accesses to the free repeater to perform communication, in a case that it is analysed by the terminal, from the state information of the first repeater, that all timeslot channels of the first repeater are occupied, and the terminal does not participate in current data communication of the first repeater; and
a second memory configured to store programs in the second processor and data generated during running of the programs.

19. The terminal according to claim 18, wherein the second processor being configured to perform communication by means of the first repeater, in a case that it is analysed by the terminal, from the state information of the first repeater, that the first repeater has an idle timeslot channel, and the first repeater is the pre-set main repeater comprises:
the second processor being configured to connect to the first repeater to perform communication, in a case that it is analysed by the terminal, from the state information of the first repeater, that the first repeater has an idle timeslot channel, the first repeater is the pre-set main repeater, and if there is no call to the terminal on other repeaters.

20. The terminal according to claim 18, wherein the second processor is further configured to:
analysing a current state of the main repeater for the terminal and the identifier of the free repeater when receiving state information of all repeaters, return back to the main repeater for the terminal in a case that the terminal does not perform data communication and the main repeater for the terminal has an idle timeslot channel, and access to the free repeater to perform communication in a case that the terminal does not perform data communication and the main repeater for the terminal has no idle timeslot channel.

21. The terminal according to claim 20, wherein the second processor is further configured to:
detect whether the main repeater for the terminal has an idle timeslot channel, when the terminal initiates a new call while receiving a call or hanging a call; stop receiving the call and switch to the main repeater for the terminal to initiate a new call, in a case that the main repeater for the terminal has an idle timeslot channel; and stop receiving the call and switch to the free repeater to initiate a new call, in a case that the main repeater for the terminal has no idle timeslot channel.

22. The terminal according to claim 21, wherein the second processor is further configured to:
switch to the main repeater for the terminal before detecting whether the main repeater for the terminal has an idle channel timeslot, in a case that a repeater on which the terminal receives the call or maintains the call is neither the main repeater for the terminal nor the current free repeater.

23-24. (canceled)
